(19) United States
(12) Patent Application Publication
(10) Pub. No.: US 2011/0276481 A1
(43) Pub. Date: Nov. 10, 2011

(54) Automated Budget Management, Multiple Payment, and Payment Authority Management

(75) Inventors: Bernard John Wright, Kew (AU); Stephen Bruce Coulter, Balgowlah Heights (AU)

(73) Assignee: CONTROLLABILL PTY LTD, Balwyn (AU)

(21) Appl. No.: 13/187,649

(22) Filed: Jul. 21, 2011

Related U.S. Application Data
(63) Continuation of application No. 12/297,918, filed on Oct. 21, 2008.
(60) Provisional application No. 60/794,286, filed on Apr. 21, 2006.

(51) Int. Cl. G06Q 40/00; G06Q 30/00

(52) U.S. Cl. 705/40

(57) ABSTRACT

A direct debit authority management system is used to facilitate bill payments involving a customer, a bank or financial body, and multiple billers who each bill the customer. A customer service module enables a customer to create or modify a plurality of direct debit authorities for a plurality of billers. A customer registration process is facilitated by the interface, the process capturing information for use in respect of multiple billers and to establish a direct debit authority for each biller before a bill is rendered by the respective biller, each direct debit authority being established based on the captured customer information. A repository stores customer direct debit authorities for multiple billers, storing customer information following the customer registration process and storing biller information following the biller registration process. The system links a customer with a biller through the direct debit authority and allows a biller to draw funds from a customer based on the stored direct debit authority.

This application is a continuation of U.S. application Ser. No. 12/297,918, filed Oct. 21, 2008, which is a U.S. national phase application of PCT/AU2007/000520, filed Apr. 20, 2007, which in turn claims priority from U.S. Application No. 60/794,286 filed Apr. 21, 2006 the contents of which are incorporated herein by reference in their entireties.

### TECHNICAL FIELD

This invention relates to automated budget management, multiple payment, and payment authority management, and relates particularly but not exclusively to such operating via an electronic communication medium where there will be management of aggregated authorities for payment of bills.

### BACKGROUND ART

Hitherto, there have been many proposals for automatic payment of bills. The bills can come from many billers, for example, leasing companies, housing loan institutions, public essential services organisations, such as, power organisations, gas organisations, sewage organisations, water organisations, and the like. Other bills are encountered such as payment of vehicle registration fees, vehicle insurance, and the like. The bills may be to individuals or to companies or organisations. Sometimes actual bills are not received, but a payment of a prior financial expense is required. Throughout this specification and the claims the terms “bill or bills” are to embrace such expense and the need for payment.

Direct debit processing is one known option to attempt to automate a bill payment process. Another solution is to allow direct debiting to a credit card facility. In each case however, the recipient of a bill, needs to set-up an arrangement for the automatic payment. This means, that the recipient of the bill must undertake a registration process for each of the biller's concerned. For example, if an electricity bill is to be paid by an automatic payment process, the biller may offer an automatic payment process to the customer. This requires the customer to then request participation in the direct debit process. The biller then sends a suitable form to the customer which must be completed and returned to the biller. The Biller must then manually process information from the form and then store the form in perpetuity to prove the validity of the authority to the Bank in case it is ever disputed. In the case where such direct debit/payment is authorised, and insufficient funds are available to make the payment, then the bank or other financial institution is required to report the non-payment to both the biller and the recipient of the bill. Notification by the Bank to the biller is by way of an electronic file. Notification to the customer is by way of a bank statement. This is done by way of traditional mail and is a burden for the billers and banks or other financial institutions. The Biller is also required to send a reminder statement by traditional mail to pursue payment and may require another payment channel to be used.

In the case where a recipient of the bill elects to make a payment of a bill using a service such as B-Pay (Registered Trade Mark), the recipient needs to become involved in every payment by accessing the B-Pay service and arranging for payment of each bill. Other forms of payment such as Internet banking, cheques, credit cards, National Posts, and payments direct to billers all require the recipient of the bill to be actively involved in the payment process for each and every bill. Except for fixed amount bills, none of these payment methods allow for the automation in respect of a variable amount and/or a variable timing of bills.

### SUMMARY

There is a need for an improved system and methods to minimise the need for individuals to intervene during bill payment processes (but still retain control).

According to one aspect of the present invention there is provided an automated budget management and multiple bill payment system comprising: at least one customer (hereinafter referred to as “Customer”), at least one bank or like financial body (hereinafter referred to as “Bank”), multiple Billers who will each bill said Customer (hereinafter referred to as “Billers”), said system having a Customer registration process, said Customer registration process requiring the Customer to commit to make regular Customer payment to the Bank for the cost of bills rendered to the Customer by the Billers so as to provide budgeted funds for bill payment, the Customer payment being based on a budget setting process involving all the anticipated bills from all chosen Billers over a period of time before registration of the customer can be completed, said Customer registration process also requiring the Customer to identify each one of the Billers, said Billers' registration process requiring each one of the Billers to identify a respective “pay into” account, said system requiring the Billers to forward bill details to both the Customer and the Bank and wherein a Biller draws funds directly from the budget funds of the customer and there is a payment of the drawn funds into the Biller's “pay into” account for payment of a bill. The drawn funds can then be directly credited to a Biller's bill receivables account.

According to another aspect of the present invention there is provided a method of electronically registering a Customer in an automated software controlled budget management and multiple bill payment system by use of an application in the System comprising: entering electronic data of a customer to identify the customer; entering customer provided electronic data of multiple billers' for whom the customer requires bills to be paid, said electronic data of multiple billers' comprising a quantum of bills expected from each biller over a period of time, totaling the quantums, and determining a customer required payment needed from a customer per salary or from an alternative periodic payment to provide funds sufficient to cover all the bills of all billers over said period of time, requiring the customer to commit to make payments of the determined customer required payment and upon that commitment being obtained, ascertaining a customers' “pay from” account into which the determined customer required payments will be made, registering the multiple billers' in the system, and linking profile details of the billers to a profile of the customer storing all linked details in a store, and then registering the customer in the system so that when a biller sends bill data to the system in respect of a customer bill, the system will be able to automate payment from the Customers' “pay from” account.

According to another aspect of the present invention there is provided a method of electronic budget management and payment of bills from multiple billers comprising, entering electronic data of a customer to identify the customer, entering customer provided electronic data of multiple billers' for whom the customer requires bills to be paid, said electronic data of multiple billers' comprising a quantum of bills expected from each biller over a period of time, totaling the quantums, and determining a customer required payment needed from the customer per salary, or from an alternative periodic payment to provide funds sufficient to cover all bills of all multiple billers over said period of time assigning a customer “pay from” account to the customer, obtaining a commitment from the customer to make the determined customer required payment into the customer “pay from” account, registering each of the multiple billers by assigning a respective “pay into” account for each biller, linking a profile of the customer to respective profiles of the billers, storing all linked details in a store, receiving electronic bill data of bills provided by the billers' to the customer, and making an automatic electronic transfer of funds from the customers “pay from” account to the billers “pay into” account to pay the amount of the bill by utilizing the linked details in the store.

### BRIEF DESCRIPTION OF THE DRAWINGS

FIG. 1 is a schematic diagram showing a prior system for bill payment.

FIG. 2 is an overview diagram showing process steps in the system shown in FIG. 1.

FIG. 3 is a diagram similar to that in FIG. 1 showing an example of an embodiment of the present invention.

FIG. 4 is a block architectural schematic view of a system in accordance with one preferred example of the present invention.

FIG. 5 is an overview diagram showing concepts utilised in the examples of FIG. 3 and FIG. 4.

FIG. 6 is a high level overview diagram showing basic steps within the system example of FIGS. 3 through 5.

FIGS. 7(a) and 7(b) show method steps for budget setting used in the example of FIGS. 3 through 6.

FIG. 8 shows method steps performed by a biller in the example of FIGS. 3 through 7(a) and 7(b).

### DETAILED DESCRIPTION

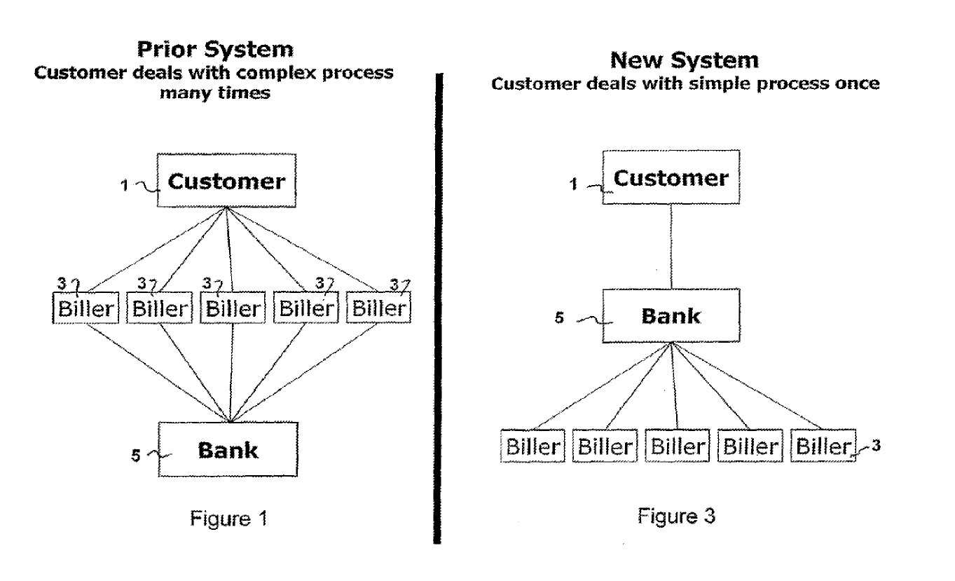

Referring firstly to FIG. 1 there is shown an overview of a prior art direct debit system involving multiple billers. Here, a single customer is shown but in practice, there will be many customers dealing with many different billers, Only one bank is shown but there may be multiple banks or like financial bodies. Customers will hereinafter be referred to as “customer” and banks and financial bodies as “banks”. In addition, each of the billers will be referred to hereinafter as billers. FIG. 1 shows that a customer 1 may be required to deal with multiple billers 3. The multiple billers 3 may be any person or organisation that will bill a customer 1. These billers may comprise, as an example, government service utility organisations such as power supply companies, gas supply companies, water supply companies, sewage supply companies, councils etc. The billers 3 may comprise any other billers that may render accounts to the customers 1. Here, the billers 3 can invite the customer 1 to participate in a direct debit payment scheme. In this case, the customers 1 must complete a direct debit authority form for each of the billers 3, and nominate a particular bank 5 from which customer funds can be drawn upon to pay the particular bills. As can be appreciated, the customer 1 deals with each biller 3 and is required to complete separate direct debit authority forms for each biller 3. While the requirements of the direct debit system are common, each biller has a different process and its own form which can make it difficult for the Customer. Typically, the customer 1 has a bank account at bank 5 from which funds for bill payment can be taken. The customer 1 may have bank accounts at multiple banks 5 and when completing the direct debit authority process, the customer 1 may nominate the particular bank 5 and the particular bank account concerned.

The process of completing a direct debit authority can be relatively complex for a customer 1 and must be repeated for each biller.

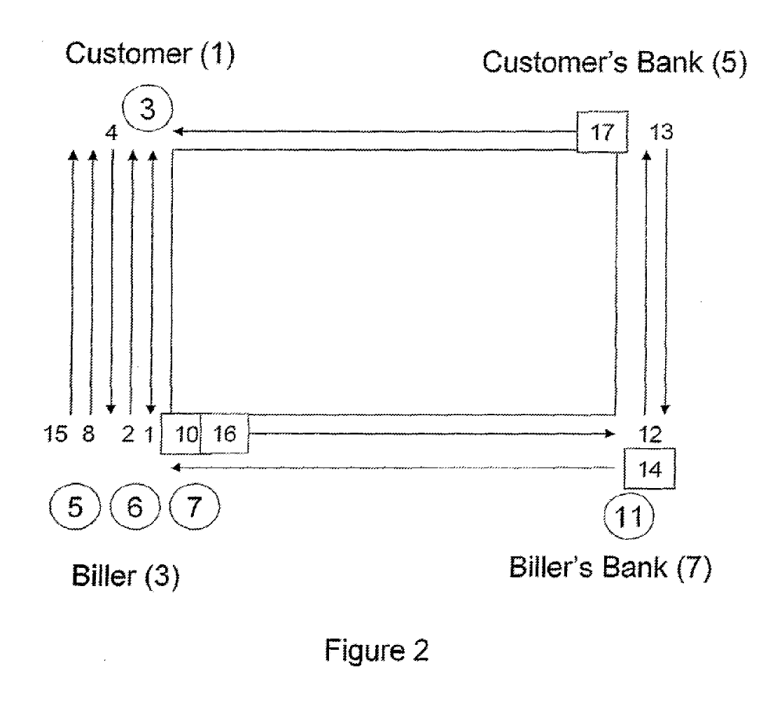

FIG. 2, outlines 17 steps that are required in some direct debit authority processing. The 17 steps are not exhaustive as some particular direct debit processes may involve fewer or greater numbers of steps. The example shown in FIG. 2 is for illustrative purposes. At step 1, it can be seen that, the biller invites a customer 1 to participate in a direct debit service. At step 2, the biller 3 provides a biller's direct debit form to the customer 1. At step 3, the customer 1 completes the form, and at step 4 sends that form to the biller 3. At step 5, the biller processes the form, and at step 6 updates a direct debit file. At step 7, the biller 3 files a paper authorisation in the biller's record 3. At step 8, the biller 3 sends an invoice to the customer 1. At step 9 (not shown) a period such as a 2 weeks period or other duration period is allowed before the bill is paid. At step 10, the biller 3 sends a direct debit file of many customers' bills to the billers' bank 7. At step 11, the biller's bank 7 splits the direct debit file into batches for individual customers' banks. At step 12, the biller's bank 7 sends electronic debit files to each of the customer banks 5 in accordance with known inter bank protocols. At step 13, the customer's bank 5 responds with an electronic payment, and provides electronic advice to the biller's bank 7 of payment, rejection of payment, and possible reason for rejection. At step 14, the biller's bank 7 advises the biller 3 of payment outcomes. At step 15, the biller follows up any rejected payments with the customer 1. At step 16, the payment process commences again at step 10. At step 17, the customer's bank 5 forwards an account statement to the customer 1.

It should be appreciated that this process occurs with each biller.

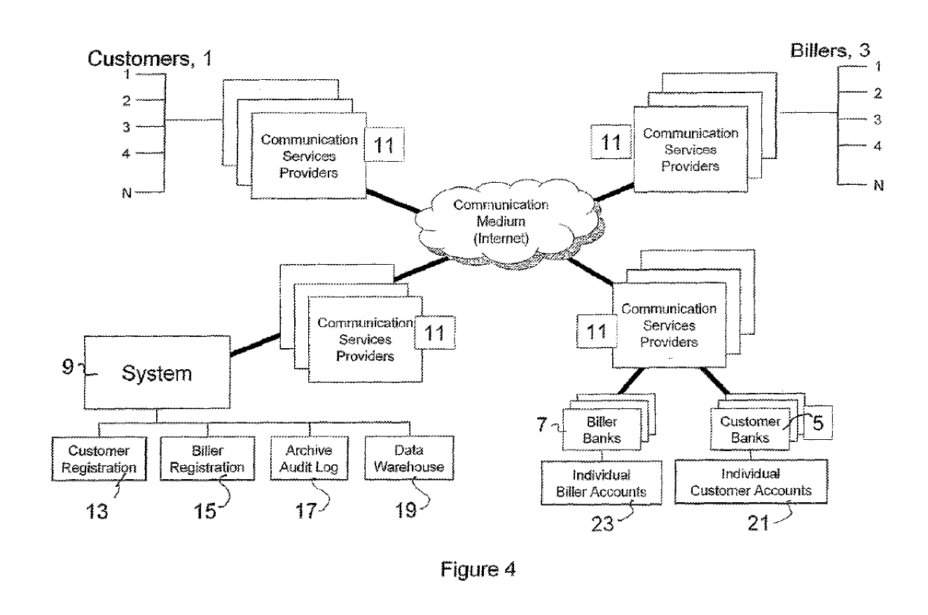

FIG. 3, is a view similar to that of FIG. 1 but showing an example of a preferred embodiment of the present invention. Here, a customer 1 deals with a customer's bank 5 in order to register in the automated system. Each of the billers 3 is required to be registered in the system by the registering of details with the biller's bank 5. Accordingly, in the example shown in FIG. 3, a customer deals directly with the bank rather than with the biller during a registration process. Thus, in the example, the customer registers multiple billers through a single process with the customer's bank 5 only once. This can be contrasted with the example in FIG. 1, where the customer 1 registers with each Biller and the Bank is not directly involved in the registration process. In the example of FIG. 3, a biller 3 is required to have a particular bill “pay into” account either at the customer's bank or a biller's 3 dedicated bank account at another bank (not shown in FIG. 3). In the example, the customer 1 is required to commit to make regular committed customer payments to the bank 5 to cover the cost of bills which will be rendered to the customer 1 by all the billers' 3, so as to provide budgeted funds for bill payment. The committed customer payment is based on a budget setting process involving all of the anticipated bills from all chosen billers over a period of time (such as 12 months) before the customer is registered in the system. The process therefore establishes bill payment authorities, for the payment of bills from the chosen billers. The system then manages those authorities.

The system of FIG. 3 requires that the billers 3 forward electronic and/or paper bill details to both the customer 1 and the customer's bank 5. A suitable period such as 2-3 weeks will be allowed prior to the bank making a payment to the billers 3 bill payment account. It can therefore be seen that, with the example, when a customer 1 is registered in the system, the customer 1 must commit to make regular committed customer payments to the bank 5 for the bills to be rendered to the customer 1 by the billers 3. The quantum will generally be equal or greater than the budgeted funds or it may, in some circumstances be less than the budgeted funds, as will be explained hereinafter. In one scenario the customer may have his/her whole salary deposited into the bank account, and be able to draw from the account for day to day matters provided that at a given time there will always be a minimum amount in the account to pay the expected bills in the budget. The regular committed payment made by the customer is based on a budget setting process involving all of the anticipated bills from all the billers over a period of time (such as 12 months) before registration of the customer 1 can be completed. Thus, in the example shown, there should theoretically be sufficient funds at the bank 5. During the 2-3 week period, given as an example above, after which funds for payment of the biller's bill is automatically electronically drawn from the customer's bank 5, the customer 1 may have the facility to suspend an automatic payment via a process to suspend a particular authority, such as if there is a dispute. In this way, the customer 1 will contact the bank 5 and modify their authority so as to stop any further payments to a disputed biller. If a dispute is raised, then the biller is not paid by the system until the payment authority is reinstated. Various scenarios may be implemented as to the way in which a dispute may be raised. This will be explained more fully in due course. Further, if the customer 1 has not made sufficient funds available to the bank 5, because of timing issues relative to the regular customer payments to the bank 5 to meet budget over the particular period (such as 12 months), then the bank 5 may have an overdraft facility which can be used, and appropriately charged to the customer 1. Depending on the bank, the bank account may have a line of credit available, and in one case this could be based on the bank holding an asset of the customer, such as a mortgage loan on an asset such as a house. In such case there could be equity in the asset, and the effect might be that bills are paid against funds contingent on an equity level agreed by the bank. In this way if funds are not deposited regularly by the customer, or there is a shortfall, the bills can nevertheless be paid by the bank by using the customer's equity in the asset, Appropriate interest may be levied against any such equity component involved in bill payment. In another example, the bank may set up a credit card account from which to pay bills rendered by the billers, and interest charged to the customer if appropriate.

It should be appreciated that with the above system, there is substantially greater certainty provided to billers of payment of bills than with the prior system disclosed in FIG. 1 where the customer 1 does not commit to have made sufficient funds in the bank 5 to enable the bills to be paid. Thus, in the example of FIG. 1, there is no budget setting process involved when a direct debit system is commenced. The responsibility for making funds available lies directly with the customer 1 itself. In the system shown in FIG. 3, the customer 1 registration process requires committed regular customer payments to the bank 5 to cover the cost of bills to be rendered to the customer 1 by the billers 3, based on a budget setting process involving all of the anticipated bills from all chosen billers over a period of time. Thus, with the example shown in FIG. 3, billers 3 will have greater confidence in participating than with the prior art direct debit system shown in the example of FIG. 1. In the case where the bank can take funds from equity in the customer's asset, the biller has greater confidence than with the prior art systems, as the biller will know that the bank will pay the bills. In such scenario, the biller will not know that the bill payments involve customer's equity.

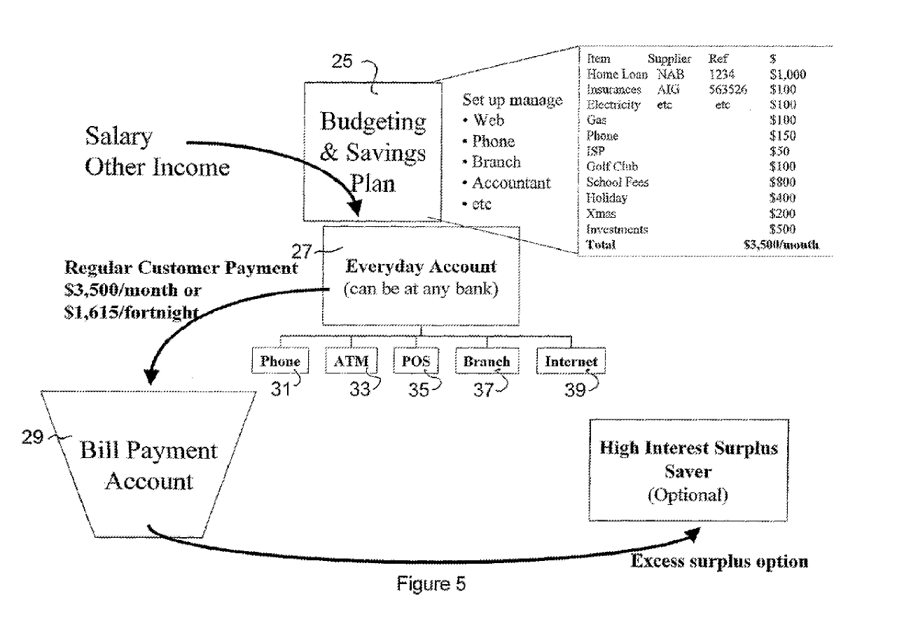

Referring now to FIG. 4, there is shown an overview system architecture diagram using a communication medium to permit electronic communication between customers 1, billers 3, customer banks 5 and biller banks 7. The communication medium can be the Internet or other forms of communication such as dedicated data lines, telephone lines, and other communication mediums known for transmitting data between entities. In the example shown in FIG. 4, a system 9 is shown that hosts basic functions of operation. The system 9 may have a website address in the Internet which can be accessed by customers 1, or alternatively, the customers 1 may enter a bank website and be directed through to the system 9 in a transparent way to the customer. In this way, the customers 1 can access their customer banks 5 through the normal portal and be internally directed through to the system 9. Alternatively, the system 9 may be resident wholly at each of the customer's banks 5. FIG. 4 shows that the customers 1 can be infinite from one customer through to N customers. Similarly, the billers 3 may be multiple billers through to biller N. Each of the customers 1, and billers 3, has a communications device such as a PC or central computer system or mobile phone that can connect with the system 9 through communication service providers 11. Communication between customer banks 5 and biller banks 7, for transferring sensitive banking data can be via known dedicated secure communication links, and can be independent of the Internet or other communication medium and can use known bank specific protocols.

FIG. 4 shows that the system 9 has a subset of systems for customer registration 13, biller registration 15, archive/audit log 17, and a data warehouse 19. FIG. 4, also shows that the customers banks 5 have access to individual customer accounts 21. FIG. 4 also shows that the biller banks 7 have access to individual biller accounts 23.

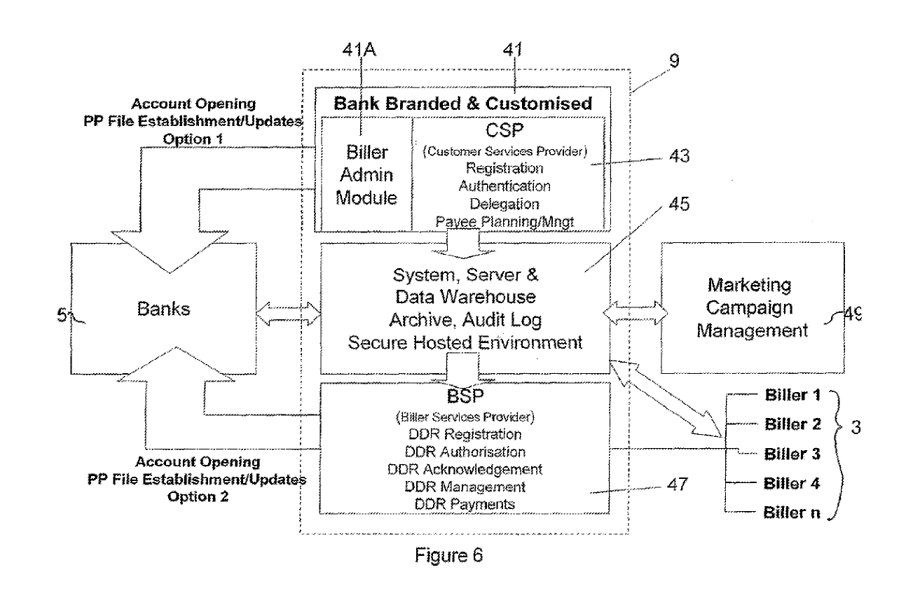

Referring now to FIG. 5, there is shown a functional overview diagram of processes involved in budget setting. This process is performed in an automated way through dedicated software. This software may be integral with the system 9 or independent and may be via a third party service provider. In the case where the software is provided by a third party service provider, a suitable communication link can be made to the third party service provider from the system 9 so that a customer 1 does not see the system in a fragmented way, but as a total system package. The budget setting process requires that all the anticipated bills from billers be itemised and the quantum of the bills estimated. FIG. 5 shows a number of potential bills from respective billers being home loan, insurances, electricity etc, through to savings and investments. It shows a total bill payment of $3,500 per month. Typically, the budget setting process is over a period of time such as 12 months. This is shown as step 25. Typically, the budget setting process is performed electronically over the Internet but may be by other communication means such as by phone, by data entry at a bank branch, or by data entry at an accountant's office or any other similar data entry arrangement. This budget setting process differs from traditional bank budget forms by actually capturing the specific provider of each service and the customers account number with each provider. FIG. 5 shows that the customer's salary and other income is normally deposited to a particular everyday account 27. The budget setting process 25 requires that $3,500 per month be deposited to a special bill payment account 29. In some situations multiple bank accounts may be involved. Such an arrangement for multiple accounts can be at the discretion of the particular customer's bank. FIG. 5 shows that the payment to the special bill payment account 29 may be at periods other than monthly such as fortnightly. FIG. 5 also shows that the everyday account 27 can be accessed by phone banking 31, ATM banking 33, point of sale banking 35, bank branch accessing 37, and Internet banking 39. The bank 5 makes bill payments to the biller's bank accounts from the special bill payment account 29 after a period of time following the forwarding of bill details to both the customer and the bank. The bill payment account 29 can be reviewed periodically and if there are excess funds in the account, then excess funds can be transferred to a high interest surplus saver. This is an optional feature that may be included if desired. In one case the account could be an interest offset account used to minimise interest payments that might apply to, for example, a loan for an asset of the customer such as a home loan. This offset account could in one example be the everyday account 27 or the bill payment account 29.

It should be appreciated that the term “payment” embraces money as the payment currency and that it also embraces other currency such as “credits” or “trading equity”, and is not to be limited only to money as the currency.

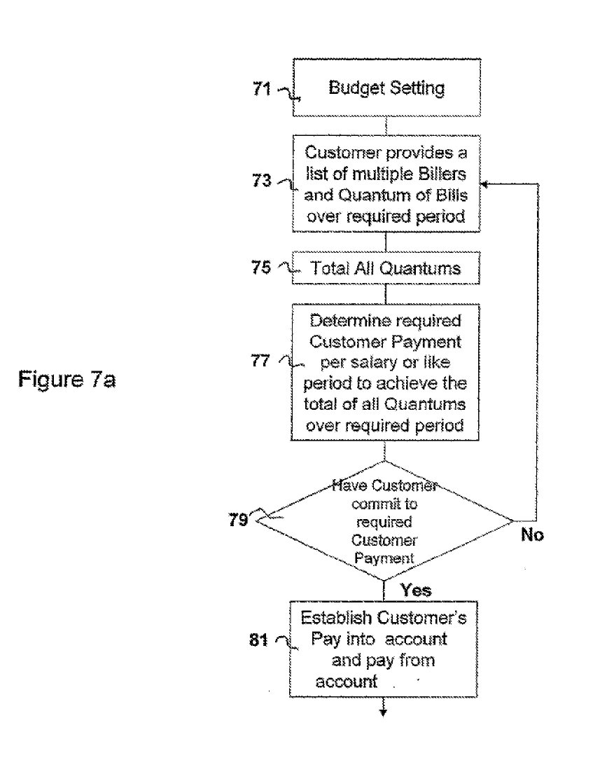

FIG. 6 is an overview functional diagram of the system. The front end application 41 includes a biller administration module 41A and a customer services provider 43, hereinafter referred to as CSP, that contains software which enables customer registration, authentication, delegation, and biller registration, planning and management. This will be described further in due course. Also within the system 9 is a software component to manage a system server, a data warehouse 19, and an archive audit log 17 (see FIG. 4). This operates within a secure hosted environment via dedicated communication lines and links such as those used between banks and other financial institutions. The application software also includes a biller services provider component 47, hereinafter referred to as BSP, that includes modules for direct debit registration, direct debit payment authorities, direct debit acknowledgments, direct debit management and direct debit payments. It can be seen that each of the modules 43, 45, and 47 is able to communicate with banks 5. It can also be seen that module 45 enables data to be extracted from the system 9 for use in marketing within a marketing module 49. It can also be seen that each of the modules 45 and 47 communicate with the billers 3.

The front end application is a web based application that is available for use by customers on a self service basis via the Internet, or alternatively over the phone via call centres using the application, in person at bank branches where staff use the application on behalf of a customer, or in person with various third parties such as accountants, financial planners and the like. The front end application captures all required customer information and stores all necessary information in the data warehouse 19 (see FIG. 5). It also provides required information to customers 1, billers 3, and banks 5. The module 41 can be bank branded to particular banks needs and therefore customised so customers 1 can recognise the system as being part of the particular banks service.

The front end application has ten functions as follows:

### 1. Customer Registration

The module 41 captures customer 1 information needed to establish various payment authorities with banks 5 and billers 3. The particular information is captured once but used many times for different billers 3. The information captured includes the following: [0062] a) Name (individual or company); [0063] b) Address; [0064] c) Mailing address if different; [0065] d) Phone numbers; [0066] e) E-mail address; [0067] f) Demographic Information (e.g. sex, age, marital status, household structure etc); [0068] g) Bank account(s) details; [0069] h) Other information that may be required for example, company business name registration number, tax file numbers and the like.

The module 41 enables the above information to be captured and passed to the system server and data warehouse in module 45 where it is securely stored. Information can be extracted from the module 45 to be provided to the biller service provider in the BSP module 47, to the banks 5, to the billers 3, and to the marketing campaign module 49.

### 2. Customer Authenticication

Here, the module 41 interfaces with bank authenticication systems to allow a customer's identity to be authenticated to bank standards. The authenticication process may vary depending on the way in which the data is input. If the input is via the Internet, then the authenticication may require “user names” and “passwords”, or other authenticication methods used by banks. If the input is via a bank branch, physical identification may be required along with checking of documentation such as drivers license, passport, and the like. If the input is over the phone, then the authenticication can be via “user names” and “passwords”, or unique pre-registered questions or other information held confidential by the customer.

It should be noted that with existing direct debit enrolment systems, there is no customer authenticication required. Customers simply fill in a form, and their details are not verified against any authenticication criteria. With the new system proposed in this example, access is authenticated and therefore the system inherently knows that any usage will be valid and indisputable.

### 3. Customer Detail Changes

After initial registration in the system, a customer 1 can update any details that have changed through any of the available input types such as via the Internet, over the phone etc. Any customer changes are then provided to all required parties such as banks 5, billers 3 and the like. The system enables the following items to be changed: a) Customer registration details, such as customer address particulars; b) Additions of billers, modifications of billers or deletion of billers; c) Changed bank account numbers; d) Changes in budgeted amounts. The system 9 automatically updates records that are maintained by billers 3, such as address of the customer 1.

It should be noted that with current direct debit systems, it is necessary for any changes to be advised to each biller individually by the customer. The process is almost entirely manual and has potential for errors. With the new system, in this example, the data is entered once and communicated by the system 9 to all required parties such as banks 5 and billers 3.

### 4. Customer Delegated Authorities

The system has a number of levels of authority for access of the information contained within the service. High level roles are in relation to customer data, biller data, and bank data. The system permits a customer to delegate authorities to third parties and to assign varying levels of authorities such as “view only”, or “change or add authorities”. A customer may delegate such authority to a trusted advisor such as an accountant, financial planner, lawyer or trustee.

In the current direct debit process, delegated authorities do not exist. If a customer wishes to permit a third party to view or access accounts, then a formal legal agreement is required such as a “Power of Attorney” or like document.

### 5. Customer Budget Planning

The budget planning tool is a web based application available through multiple, input means that captures, calculates, stores and allows access to and modifications to be made to a customer's requirements. The planning tool is set up to allow the customer to have control over how much money is expected to be required to meet bill commitments, and to allocate expenditure accordingly. The budget planning tool captures customers expected expenditure amounts for each biller in categories. This is shown in FIG. 5 where there is shown a list under the budget setting process showing particular billers. These are of course exemplary and other biller types may be included. The tool is then set to determine the total expenditure over a given period such as an annual period, and to include a safety buffer. The total amount is then converted to a repayment equivalent (weekly, fortnightly, monthly, etc). This information is then passed to and stored in the system server in module 45 and in the data warehouse from where it can be accessed to establish the necessary payment authorisations for particular billers, as to be described in relation to steps 7 and 8 hereinafter. Because the customer can dynamically update data in the planning tool, the budget setting process is dynamic and keeps track instantly of customer's needs and payment commitments. Known budget tools are static, at a point in time that are not part of an actively managed budgeting and budget implementation process. As such they quickly date and become less relevant and useful. The present system minimises this problem.

### 6. Biller Provided Details

The system captures individual biller details that include biller provided name, biller provider ID/Code, customers unique account number (if available) with each biller. Security validation processes using various check digit algorithms can be used to ensure that the details are correctly validated for each biller at the time of entry. In this way, by using check digit algorithms, accuracy can be ensured. The entered information is passed to and stored in the system server and data warehouse within module 45 where it can be subsequently accessed for use. Current direct debit systems do not capture and validate the biller details in a way that the details can be stored and used to establish, modify and cancel customer authorities electronically. The present system enables these features to be achieved. The present system also permits authorities to billers to be provided in an electronic form compatible with their systems and accessible on-line.

### 7. Establishes and Permits Modification of Bill Payment Authorities

The system takes captured customer and biller information and formats that information for storing in the system server and data warehouse for subsequent use. It also electronically forwards particulars to required billers concerning establishing, modifying or cancelling one or more bill payment authorities at a single point on-line. Since any authority has originated under customer control via appropriate passwords and the like, it can be regarded as trusted advice that does not require any subsequent verification. The system receives batch notification for each biller authorised by a customer, and dispatches that advice to respective billers. The biller can then confirm acceptance to complete the process.

The example disclosed above contrasts significantly from current direct debit systems that require customers to seek application forms from billers for any establishment, modification or cancellation of authority. In some cases, a letter to a client's bank is sufficient authority to cancel a payment but again this requires paper documentation trail. The example above is totally electronic.

### 8. Establishes and Permits Modifications of Bank Transfer Authorities.

The biller administration module 41 takes the expected expenditure bill information input by a customer and calculates the average expenditure per salary cycle or other alternative periodic payment cycle. It then formats and forwards an authority to the system for electronically forwarding onto the customers bank to permit establishing, modifying or cancelling a transfer to the customers dedicated account, from the customers everyday bank account from which payment is extracted, or directly from the customer's salary. Some customers may chose to utilise their existing bank account for the service, such as when it is a mortgage secured line of credit for example.

### 9. Biller Administration

Here, the biller administration module 41 permits a biller to access the system via a secure authenticated interface. Here, the biller logs into the system. The system may provide for individual users at the billers' premises to have a unique identification for audit processes. In addition, the unique identification of particular users at the biller can provide varying authority levels.

The biller administration module 41 provides a number of functions: a) Biller preferences with regard to file formats, and delivery methods; b) Authority batches are alerted to the biller; c) Biller can acknowledge receipt and processing of authorities; d) Billers can look-up all authorities stored within the system for a biller; e) Billers can download customer information, to which they are permitted access for integration into customer records and CRM (Customer Relationship Management) records; f) Billers can run various MIS (Management Information System) reports into customer profiles and behaviour; g) Billers can run marketing campaigns through the marketing module 49 if so permitted by the customer with respect to each markets privacy regulations or other legislation.

### 10. Bank Branded and Customised

The biller administration module 41 delivers functionality to all licensed users of the system such as banks, and financial advisers. In this example, banks are able to customise the core system site to the banks logos and designs, product names, forms and the like. In addition, the system may permit use of a particular Trade Mark for this system, which may be appropriate.

Referring now to the module 45, it can be seen that this provides a secure hosted environment for the system server, the data warehouse, and an archive/audit log, all in the front end processing. This is a central repository for all data that is collected, required and generated by the system whether from customer 1, billers 3 or banks 5. It is hosted in a secure environment meeting the highest possible industry security standards. The details of this have not been included but are well known in banking and other like industries including government and military organisations. In addition, the module 45 has access protocols designed to take into account national privacy principles and customer consents. Again, this has not been disclosed in detail as the concepts are well known in banking and other industries. The environment of operation of the module 45 provides back-up and redundancy for running all application programs, and data protection. Digital certificates and public key encryption technologies are used to identify and authenticate trusted users.

The module 45 has five basic functions as follows:

### 1. Secure Host Environment

The system application delivers information directly to banks 5 and billers 3. The environment is designed to meet the highest security and performance standards of those organisations, and follows known protocols. The application hosting is outsourced to a third party provider to provide a secure hosted environment with redundancy and back-up standards required by banks, billers and the industry generally. Such systems are well known and in use by banks for some functions such as e.g. CRM, payment gateways, and IT outsourcing contracts.

### 2. Data Warehouse

The data warehouse is a central repository for all information captured and generated by the system. It is centrally stored on behalf of all banks 5 and billers 3. The data can be accessed according to authorised permits and privileges. Information stored and managed in the data warehouse includes: a) all customer 1 details, captured once and stored in a single place so as to be readily updateable and accessible; b) customer payment authorities for billers; c) records of all participating billers 3 and their details and bill payment account; d) data base of all customer budgets during the budget setting process, and the details thereof including the particular dedicated customer account into which budgeted payments are made and from which the system can take payments to pay bills rendered by billers 3. The customers' details are linked relative to the billers' details as payment authorities and stored in the data warehouse. Known data warehouse technologies are utilised in the data warehouse for data control.

### 3. MIS Database

The system will generate large amounts of information over time concerning customers 1, billers 3 and banks 5. This information can be interrogated by dedicated application software to provide information such as a) individual customer expenditures, histories and trends over time; b) household expenditure patterns by demographic segments; c) customer expenditure patterns by billers or categories of bills; and d) other information that can be used in marketing.

### 4. Source Data for System Invoicing.

The database warehouse maintains information relevant for invoicing banks 5, biller's banks 7, billers 3 and customers 1. This information can include the following: a) number of plans active for each bank (i.e. the number of customers 1 with each bank); b) number of direct debit authorisations created, modified or cancelled for each biller 3; c) number of payments processed by the system on behalf of billers 3; d) number of customer 1 detail changes advised by billers 3; e) number of customers 1 using the system to detail changed service; f) MIS reporting provided to customers 1; g) marketing and event detection services for banks 5 and billers 3; h) number of alerts generated for customers 1. (The alerts may comprise information that the funds available to pay a particular bill are inadequate and that the customer has invoked an overdraft facility with a particular percentage rate interest component.)

### 5. Annual Reviews

The system maintains and allows for a process of review of the customer's budgets over time, and on an anniversary of the period (or at other periods as determined) and will do the following: a) apply CPI/inflation/cost of living indexing to a customers budgeted amounts; b) generate an updated budget and calculate a new amount to be transferred on each cycle of payment into the specialised account from which bills are paid; c) provide a file to each bank 5 to allow the bank 5 to send annual review letters to each of its customers 1; d) based on each banks customer management protocols, updated customer budgets will be alerted to customers relationship managers e) where delegated authorities exists for third parties access, such as accountants and financial planners, updated budgets can be notified to these delegated authorities for use in their service to the customers; f) identify key gaps in a customers authorised billers 3 so a bank 5 or a biller 3 can target customers 1 or billers 3 to participate in the system

The biller's service provider module 47 includes a number of application programs responsible for providing electronic data to billers 3 and banks 5, to facilitate the establishment of an authority, a modification and/or a cancellation of payment authorities. These application programs receive information from the system front end application in module 43 or from the module 45. The data information can be transformed by the application programs in the biller service provider module 47 so that the data is formatted to meet industry, bank, and billers standards. The application program also has a capacity to manage and submit payments to the banking system should billers require this service.

The biller's service provider module 47 has four functions as follows:

### 1. Direct Debit Registration (DDR)

The biller service within the system: a) receives information from the front end within the customer service provider module 43 for each biller 3 requested by each customer 1. This information may be file particulars relating to the biller and its bill payment account particulars. b) processes information to a format compatible with a direct debit (or other payment system); c) Sorts customers requests by biller 3; d) generates batch files to be sent to the biller 3 on an agreed schedule, or on a real time basis; e) sends a file to the biller 3 or allows the biller to request a file, in the format and media requested and agreed with the biller (as stored in step 9 In the customer service provider module 43 of the biller administration module 41); f) updates the biller administration module 41 with batch file details; g) sends an alert to the biller 3. This, for example, may include information that the customer has withdrawn its services from the bank 5, or that the customer 1 has disputed a bill.

### 2. DDR Acknowledgement

The system services batch billing of billers according to authorisations. The system therefore can send an alert to a biller 3 during each batch. The acknowledgment process includes the following: a) biller 3 logs into the biller administration module 41; b) biller 3 reviews batch file which shows customer details; c) biller 3 indicates acceptance and processing of each request to be part of the system; d) the system reconciles acceptances with batches; e) the system follows up exceptions with billers 3 to ensure all customer 1 requests are enacted. This process differs from current paper based direct debit systems which do not have a closed loop to ensure requests by customers are accepted and actioned.

### 3. DDR Management

Here the system: a) maintains a database of all payment authorities received from customers 1; b) is accessible by billers 3 to check the provided authorities and to validate authorities when required; c) is accessible to confirm authorities provided and if account/payments are disputed by customers. Current direct debit management processes require each biller 3 to keep paper copies of payment authorities in case there is a challenge. The system in this example does not require paper authorities and maintains an electronic record of all authorities provided that can be accessed at any time by a biller 3.

### 4. DDR Payments

Here, the system has an option of processing and managing payment for billers 3 if requested. If requested, the following occurs: a) biller 3 requests a file of customers 1 with account and payment due details; b) a file is then created with the customer 1 payment authorities file, and a direct debit file is then created to bank standards. c) the system submits the file to a bank 5; d) the bank 5 processes the file; e) the bank advises the system of payments completed and any exceptions; f) the systems provide a file back to the biller 3 to update payment records. The current direct debit systems require each biller to lodge their own files direct with their bank. The above example permits billers to manage payments and processing.

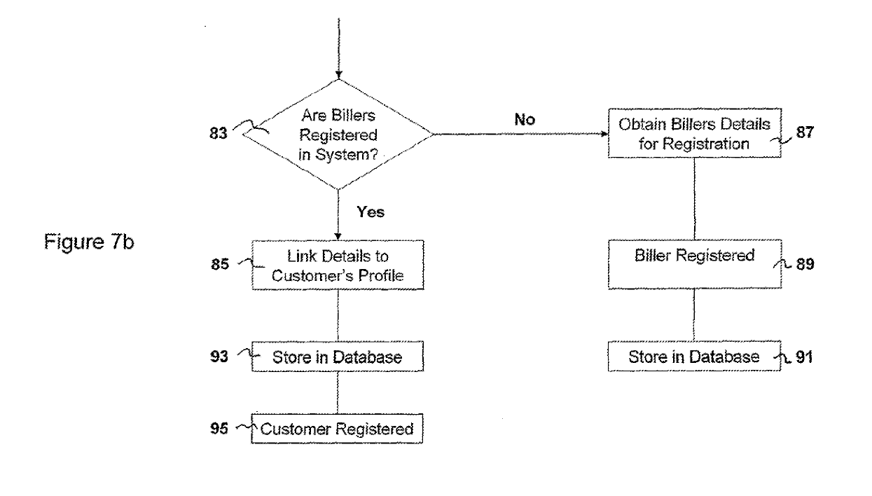

Referring now to FIGS. 7a and 7b, various method steps involved in a budget setting and customer registration and biller registration process are shown. Here, at step 71 a customer 1 is directed to a budget setting application within the customer service provider module 43. At step 73, the customer provides a list of multiple billers and the quantum of bills from those billers over a required period such as 12 months. The particular billers can be ascertained by the customer from past bills rendered by the billers 3 to the customer 1. The customer 1 can determine the quantum of such bills over a required period (such as 12 months) from past bills received from the particular billers 3. At step 75, all the quantums of the bills are totaled. At step 77, the system determines a required customer payment cycle per salary payment period or like period. For example, if the customer 1 is paid fortnightly, then at step 77 the system will determine the fortnightly payment required to achieve the total of all quantums over the required period. If the customer 1 is paid monthly, then step 77 will determine the monthly customer payment required to achieve the total of all quantums over the required period. At step 79, customer 1 is required to commit to the required customer payment determined at step 77. If the answer is NO, then the customer is redirected to step 73 so the list of multiple billers can be adjusted such as by deleting one or more billers. If the answer is YES at step 79, then the system requires the customer 1 to establish or nominate a customer's “pay from” account from which all bills will be paid. This process occurs at step 81 and provision exists for the account to be automatically established from within the system if the Bank's system permits. At step 83, the system determines if the billers identified by the customer 1 at step 73 are already registered in the system. If the answer is YES, the system proceeds to step 85 and links the details of the customer 1 with the billers 3 and the quantum of such bills. In addition, the linking involves noting the particular “pay from” account established at step 81. If the billers are not registered in the system, the system then proceeds to step 87 where details of billers are obtained for registration in the system. This process may involve an interrogation of industry databases or other banks or financial institutions for the required details of billers. If biller's details are present at some remote location then the details are obtained and the biller is registered at step 89. The billers details are then stored in the database in module 45 at step 91. Simultaneously, the biller information is then linked to the customers profile at step 85. The linked details are then stored in the database in module 45 at step 93. At step 95, the customer is then finally registered in the system.

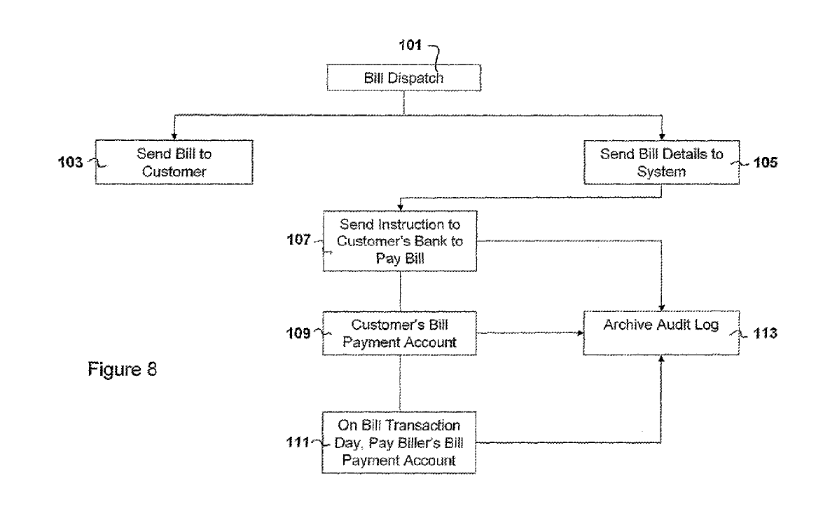

Referring now to FIG. 8, there is shown the process steps involved in a biller 3 forwarding a bill to a customer 1, and to the system to enable payment of the bill. Here, at step 101, a bill is dispatched on behalf of the biller 3. This bill may be dispatched directly from the biller 3 itself or by a third party transaction service organisation acting on behalf of the biller 3. The bill is then sent to the customer at step 103. This may be done electronically or via conventional paper mail or both. Before or at the due date the Biller sends a file to their Bank of customer bill payments required and the due date. On the due date this file is processed and payments made in line with the payment authorities held. The period between bill issuance and payment due date enables the customer 1 to dispute a bill and to suspend payment in the system if required. At step 109, the customer's bill payment account is debited for the amount of the bill and at step ill, the debited quantum is paid into the billers bill “pay into” account such as accounts receivable account. An archive audit log occurs at step 113 concerning all transaction details.

The above description has outlined one example of a preferred embodiment. It should be appreciated that many variations may be made to the example described above and yet still be within the inventive concept. For example, in an alternative embodiment, the system may be set-up so that a customer must authorise payment of bills for each bill received by the customer. In addition, there may be a facility provided to allow the customer to select certain billers that can be automatically paid, where as other billers need to receive an approval from the customer prior to the billing being made.

Throughout the description of the example of the preferred embodiment, the system 9 has been shown independent of a bank 5. It should be appreciated however, that for the purposes of this specification, including the claims, the term “bank” is to embrace the system 9.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the publication forms a part of the common general knowledge in the art in any country.

What is claimed is:

1. A computer-based method of managing authorizations for payment of bills rendered by one or more billers to a customer comprising:
storing into a database electronic data of multiple billers for whom the customer requires bills to be paid;
storing into a database electronic data of a customer to identify the customer for use in respect of multiple billers, said electronic data of one or more billers comprising a quantum of bills expected from the one or more biller over a period of time;
totalling the quantums, and determining a customer required payment needed from the customer per salary, or from an alternative periodic payment to provide funds sufficient to cover all bills of the one or more billers over said period of time;
assigning a customer “pay from” account to the customer;
obtaining a commitment from the customer to make a determined customer required payment into the customer “pay from” account and holding “pay from” account details in a database;
registering into a database a corresponding one or more billers as authorized by the customer by assigning a respective “pay into” account for the respective one or more billers and storing details in a database;
computer linking a profile of the respective one or more billers to a profile of the customer as a managed authorization for bill payment by the customer;
storing all linked details in a store;
obtaining and storing a payment authority for each biller to be paid by the customer with the system prior to the biller rendering a bill, each payment authority being based on the stored electronic data of the customer;
whereby on receiving electronic bill data of a bill provided by a biller to the customer by an entity permitting computer transfer from the customer's “pay from” account, so funds can be automatic computer electronically drawn from the customer's “pay from” account to the biller's “pay into” account to pay the amount of the bill by utilizing the linked details in the store and the data stored in the databases without further action from the customer on the basis of the established authority of the respective biller.

2. A direct debit authority management system to be used to facilitate bill payments involving a customer, a bank or financial body, and multiple billers who each bill the customer, the system comprising:
a customer service module enabling a customer to create or modify a plurality of direct debit authorities for a plurality of billers;
a customer registration process facilitated by the interface, the process capturing information for use in respect of multiple billers and to establish a direct debit authority for each biller before a bill is rendered by the respective biller, each direct debit authority being established based on the captured customer information;
a repository for storing a plurality of direct debit authorities of a plurality of customer for a plurality of billers, storing customer information following the customer registration process and storing biller information following the biller registration process;
the system linking a customer with a biller through the direct debit authority, the system allowing a biller to draw funds from a customer based on the stored direct debit authority.

3. The direct debit authority management system as claimed in claim 2, wherein the system is arranged to provide a customer's direct debit authority to the biller that is related to the direct debit authority.

4. The direct debit authority management system as claimed in claim 2, further comprising:
a biller service provider module arranged to communicate with a biller and the customer service module.

5. The direct debit authority management system as claimed in claim 2, wherein the customer service module is arranged to allow a customer to input customer information needed to establish a direct debit authority and to communicate with the storage repository to store customer information in the repository.

6. The direct debit authority management system as claimed in claim 5, wherein the customer information can be any one or more of the following:
Name
Address
Mailing address
Phone numbers
Email address
Bank account details
Tax number
Credit card details

7. The direct debit authority management system as claimed in claim 2, wherein the customer service module allows a customer to add, modify, deactivate, suspend or delete billers via a customer interface, the system automatically updating and storing changes made by the customer.

8. The direct debit authority management system as claimed in claim 2, wherein the customer service module is arranged to allow customer to create new direct debit authorities based on customer and biller information stored in the repository.

9. The direct debit authority management system as claimed in claim 2, wherein the system is arranged to enable a customer to suspend a direct debit authority for a particular biller.

10. The direct debit authority management system as claimed in claim 2, wherein the customer service module comprises a customer interface arranged to receive customer inputs and in communication with the system and arranged to communicate customer inputs to the system.

11. The direct debit authority management system as claimed in claim 2, further comprising:
a biller administration module arranged to receive biller information from a biller.

12. The direct debit authority management system as claimed in claim 11, wherein the biller information can be any one or more of the following:
Biller name
Biller account details
Biller preferences with regard to file formats
Biller preferences with regard to delivery methods
Biller address

13. The direct debit authority management system as claimed in claim 2, wherein the biller administration module comprises a biller interface arranged to receive biller inputs and in communication with the system and arranged to communicate biller inputs to the system.

14. The direct debit authority management system as claimed in claim 4, further comprising:
a biller service provider module arranged to be in communication with the repository, the customer service provider, the biller administration module and the biller interface.

15. The direct debit authority management system as claimed in claim 4, wherein the biller service provider module is arranged to receive a direct debit authority created by a customer and send the direct debit authority to a biller.

16. The direct debit authority management system as claimed in claim 4, wherein the biller service provider module is arranged to format the created direct debit in a biller preferred format.

17. A computer based method for managing direct debit authorities to be used to facilitate bill payments involving a customer, a bank or financial body, and multiple billers who each bill the customer, the method comprising the steps of:
receiving instructions from a customer to create or modify a plurality of direct debit authorities for a plurality of billers;
capturing customer information from a customer registration process for use in respect of multiple billers and to establish a direct debit authority for each biller before a bill is rendered by the respective biller, each direct debit authority being established based on the captured information;
storing a plurality of direct debit authorities of a plurality of customer for a plurality of billers,
storing customer information following the customer registration process; and
enabling a biller to draw funds from a customer based on the stored direct debit authority.

18. The method for managing direct debit authorities as claimed in claim 17, wherein the customer information is received via a customer service.

19. The method for managing direct debit authorities as claimed in claim 17, wherein the customer information can be any one or more of the following:
Name
Address
Mailing address
Phone numbers
Email address
Bank account details
Tax number
Credit card details

20. The method for managing direct debit authorities as claimed in claim 17, comprising the additional steps of:
receiving instructions regarding adding, modifying, suspending or deleting a biller from a customer; and
updating the stored information regarding billers based on new instructions from the customer.

21. The method for managing direct debit authorities as claimed in claim 17, wherein a direct debit authority is created using stored biller information.

22. The method for managing direct debit authorities as claimed in claim 17, wherein the step of capturing includes receiving biller information via the biller administration module.

23. The method for managing direct debit authorities as claimed in claim 22, wherein the biller information can be any one or more of the following:
Biller name
Biller account details
Biller preferences with regard to file formats
Biller preferences with regard to delivery methods
Biller address

24. The method for managing direct debit authorities as claimed in claim 18, further comprising:
transmitting a customer's direct debit authority to the biller that is related to the direct debit authority.

25. The method for managing direct debit authorities as claimed in claim 18, further comprising:
formatting the direct debit authority in a preferred format of a biller prior to transmitting the direct debit authority to the biller.
